(19) United States
(12) Patent Application Publication
(10) Pub. No.: US 2018/0370288 A1
(43) Pub. Date: Dec. 27, 2018

(54) COMPOSITE MATERIALS CONSISTING OF AN ORIENTED STACKING OF HARD-SOFT MIXTURES FOR MECHANICAL COUPLING IN THE PRODUCTION OF TIRE TREADS

(71) Applicants: COMPAGNIE GENERALE DES ETABLISSEMENTS MICHELIN, CLERMONT-FERRAND (FR); MICHELIN RECHERCHE ET TECHNIQUE S.A., Granges-paccot (CH)

(72) Inventors: JOSE-CARLOS ARAUJO DA SILVA, Clermont-Ferrand (FR); MASAYUKI MAESAKA, Clermont-Ferrand (FR); PHILIPPE MANSUY, Clermont-Ferrand (FR)

(73) Assignees: COMPAGNIE GENERALE DES ETABLISSEMENTS MICHELIN, CLERMONT-FERRAND (FR); MICHELIN RECHERCHE ET TECHNIQUE S.A., Granges-paccot (CH)

(21) Appl. No.: 16/065,346

(22) PCT Filed: Dec. 15, 2016
(86) PCT No.: PCT/FR2016/053460

§ 371 Date: Jun. 22, 2018

(30) Foreign Application Priority Data
Dec. 22, 2015 (FR) 1563041

(51) Int. Cl. B60C 11/00; B60C 11/03; B60C 1/00

(52) U.S. Cl. CPC B60C 11/0008; B60C 11/0041; B60C 2011/0025; B60C 1/0016; B60C 11/0302

(57) ABSTRACT

The present invention relates to materials making it possible to generate mechanical coupling in elastomeric compositions, of use especially for the manufacture of tyre treads. It relates in particular to a tread comprising a stack of layers having high and low stiffness moduli.

### TECHNICAL FIELD

The present invention relates to materials making it possible to generate mechanical coupling in elastomeric compositions, of use especially for the manufacture of tyre treads.

### State of the Art

Improving the wear resistance of tyres is a highly important issue, especially due to the cost of tyres. This issue concerns all types of tyre, but is even more important for tyres for heavy-duty vehicles and civil engineering vehicles, due to the economic impact associated with the immobilization of the vehicles while the worn tyres are replaced.

Particularly in the field of civil engineering, and in particular in the mining sector, tyres are essentially used on ore or coal extraction sites, and also in quarries. In a simplified way, the use consists of:
a loaded outward cycle, generally uphill for ore and coal, generally downhill for quarries, for transporting the ore or spoil to unloading zones (“crusher” for ore, “dumping zones” for spoil);
an empty return cycle, generally downhill for mining use, generally uphill for quarry use, to return to the loading zones.

The tyres fitted to the mining dumpers in question are, as a general rule, fitted on the front axle of the vehicle for the first third of their life, then changed around and fitted as part of a twinned pair to the rear axle for the remaining two thirds of their life. The driving torque is transmitted via the rear axle, and the braking torque is also virtually exclusively transmitted via the rear axle, using engine braking (thermal or electrical in the case of a transmission of this kind).

From the mine manager's perspective, the transport of ore and of spoil represents a significant share of the mine's operating costs, and within this contribution, the share represented by tyres is significant. Limiting the rate of wear is therefore a key contributor to reducing the operating costs. From the tyre manufacturer's perspective, developing technical solutions that make it possible to reduce the rate of wear is therefore an important element of strategy.

Mining tyres of the rear axle of rigid dumpers are subject to high forces (passage from driving torque to braking torque) since the slopes of the tracks for exiting open-pit mines are generally of the order of 8.5 to 10%. This slope value makes it possible to optimize the productivity of the vehicles with the currently available powers. These stresses are reflected in relatively rapid tyre wear. It is therefore a question of proposing a technical solution that makes it possible to improve the wear performance of the tyres on this axle, both under loaded driving torque and under empty braking torque.

Numerous solutions have been sought for increasing the wear resistance so as to prolong their service life as much as possible and thereby reduce the operating costs.

In the field of tyres for civil engineering vehicles, it is known to use natural rubber, a reinforcing filler of carbon black type and additives customarily used for these tyres, in treads for off-road vehicles. The wear resistance of this type of tyre is generally improved by optimizing the nature of its constituents or of its tread patterns. For example, in order to improve the wear resistance of off-road tyres, application WO 2013/041400 proposes integrating a certain amount of polybutadiene with a high vinyl content into an isoprene matrix of a tread composition.

In the field of tyres for vehicles running on a bituminous surface, such as passenger vehicles or the majority of heavy-duty vehicles, a solution for improving wear resistance was proposed in patent U.S. Pat. No. 8,272,412 by integrating, into an elastomer tread composition, glass fibres oriented at 45 degrees relative to the running direction in the circumferential plane.

Yet, it is still necessary to provide improved solutions for improving the wear resistance of tyres in general, and particularly for tyres for heavy-duty vehicles or civil engineering vehicles.

### Account of the Invention

Consequently, the present invention relates to a novel formulation for tyres, making it possible to significantly improve their wear resistance.

The subject thereof is especially a tread comprising at least one tread pattern consisting of a plurality of parallel layers adjacent to one another, the layers being oriented within the tread pattern parallel to a plane which is (i) perpendicular to the equatorial plane and (ii) oriented at an angle α expressed in degrees relative to the radial plane, the angle α being defined by the formula α=45+/−x, in which x is within a range extending from 10 to 30; the plurality of layers comprising layers formed by a composition having a low stiffness modulus, the modulus of extension at 5% deformation of which is within a range extending from 2 to 8 MPa and layers formed by a composition having a high stiffness modulus, the modulus of extension at 5% deformation of which is within a range extending from 30 MPa to 50 GPa.

The tread in accordance with the invention may either be in the uncured state (before crosslinking or vulcanization) or in the cured state (after crosslinking or vulcanization). It may be in the form of a semi-finished product which may be used in a tyre or on a retreaded carcass, or else be already arranged on a tyre or tyre casing.

Definitions

The expression “part by weight per hundred parts by weight of elastomer” (or phr) should be understood as meaning, for the purposes of the present invention, the share by weight per hundred parts by weight of elastomer or rubber.

In the present document, unless expressly indicated otherwise, all the percentages (%) shown are percentages (%) by weight.

Furthermore, any range of values denoted by the expression “between a and b” represents the range of values extending from more than a to less than b (that is to say, limits a and b excluded), while any range of values denoted by the expression “from a to b” means the range of values extending from a up to b (that is to say, including the strict limits a and b). In the present document, when a range of values is denoted by the expression “from a to b”, the range represented by the expression “between a and b” is also and preferentially denoted.

In the present document, the expression composition “based on” is understood to mean a composition comprising the mixture and/or the reaction product of the various constituents used, some of these base constituents being capable of reacting or intended to react with one another, at least in part, during the various phases of manufacture of the composition, in particular during the crosslinking or vulcanization thereof. By way of example, a composition based on an elastomeric matrix and on sulfur comprises the elastomeric matrix and the sulfur before curing, whereas, after curing, the sulfur is no longer detectable as the latter has reacted with the elastomeric matrix with the formation of disulfide bridges.

In the present document, the expression “predominantly comprises” is understood to mean comprises more than 50%. This may, for example, be more than 60%, 70%, 80%, 90%, or even 100%.

At a given point on a tyre, the circumferential direction, also referred to as the longitudinal direction, is the direction tangent to a circle centred on the axis of rotation of the tyre. It is parallel to the running direction of the tyre. The axis of rotation of the tyre is the axis about which it turns in normal use. At a given point on a tyre, the transverse direction, also referred to as the lateral direction, is parallel to the axis of rotation of the tyre. At a given point on a tyre, the radial direction is a direction that intersects the axis of rotation of the tyre and is perpendicular thereto. “X” is a direction parallel to the circumferential direction, “Y” is a direction parallel to the transverse direction, and “Z” is a direction parallel to the radial direction. The directions XYZ form an orthogonal frame of reference (FIG. 1).

“Fx” is intended to mean the horizontal component of the ground forces on the tyre in the running direction of the tyre. Reference is made to driving torque when a positive force Fx is applied, and braking torque when a negative force Fx is applied. “Fy” is intended to mean the horizontal component of the ground forces on the tyre in the transverse direction of the tyre. “Fz” is the vertical component.

“Level of coupling” is intended to mean the ratio of the horizontal component Fx of the ground forces on the tyre (or ground forces on the test specimen) to the vertical component Fz of the ground forces on the tyre (or ground forces on the test specimen).

A radial plane “YZ”, also referred to as meridian plane, is a plane which contains the axis of rotation of the tyre. A circumferential plane “XZ” is a plane perpendicular to the axis of rotation of the tyre. The circumferential median plane, also referred to as the equatorial plane, is a plane which is perpendicular to the axis of rotation of the tyre and which divides the tyre into two halves.

In the present document, “tread pattern” is intended to mean a more or less complex system of elements in relief, separated from one another by cutouts. The elements in relief of a tread pattern may be ribs or tread blocks.

“Rib” is intended to mean an element in relief formed on a tread and extending essentially along the circumferential direction, this element being delimited either by two cutouts or by a cutout and an edge of the tread. A rib comprises two lateral walls and a contact face, the latter being intended to come into contact with the road surface during running. This element extends in the circumferential direction and encircles the tyre (legend (2) of FIG. 1).

“Tread block” is intended to mean an element in relief formed on a tread, this element being delimited by one or more rectilinear, curved or circular, cutouts, and optionally by an edge of the tread. A tread block also comprises a contact face, the latter being intended to come into contact with the road surface during running (legend (3) of FIG. 1).

The cutouts may either be grooves or sipes, depending on their thickness, that is to say the distance between the walls of material delimiting them, and their function during running. The thickness of a groove is typically at least equal to 1 mm, whereas the thickness of a sipe is typically at most equal to 1 mm. When the tyre is running, the walls of material of a groove do not come into contact with one another, whereas the walls of material of a sipe at least partially come into contact with one another.

In the present document, a “cutout” denotes a groove and corresponds to the space delimited by walls of material facing one another and spaced apart from one another by a non-zero distance, preferably a distance greater than 1 mm, for example greater than 2, 3, 4 or 5 mm (legends (4) and (5) of FIG. 1).

Within the context of the invention, the carbon-based products mentioned in the description may be of fossil or biobased origin. In the latter case, they may partially or completely result from biomass or be obtained from renewable starting materials resulting from biomass.

Composition Having a Low Stiffness Modulus

According to the invention, the tread consists of a plurality of layers comprising layers formed by a composition having a low stiffness modulus. “Composition having a low stiffness modulus” is intended to mean a composition, the modulus of extension at 5% deformation of which is within a range extending from 2 to 8 MPa. Preferably, the modulus of extension at 5% deformation of the composition having a low stiffness modulus is within a range extending from 3 to 6 MPa.

Those skilled in the art can measure the stiffness, the modulus of extension at 5% deformation of which according to a method based on standard NF ISO 37 of December 2005 on a type 2 dumbbell test specimen and measure the elastic modulus at 5% deformation at 23° C.

The composition having a low stiffness modulus may advantageously be an elastomeric composition based on an elastomeric matrix, at least one reinforcing filler and at least one crosslinking system.

Elastomeric Matrix of the Composition Having a Low Stiffness Modulus

According to the invention, any elastomeric matrix known to those skilled in the art for the manufacture of treads may be used in the composition having a low stiffness modulus of the tread pattern of the tread according to the invention.

For example, the elastomeric matrix may comprise a diene elastomer, preferably an elastomer selected from isoprene elastomers, butadiene and styrene copolymers, polybutadienes and mixtures thereof.

The term “diene elastomer” should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

These diene elastomers are well known to those skilled in the art and can be classified into two categories; “essentially unsaturated” or “essentially saturated”. “Essentially unsaturated” is understood to mean generally a diene elastomer resulting at least in part from conjugated diene monomers having a content of units of diene origin (conjugated dienes) which is greater than 15% (mol %); thus, diene elastomers such as butyl rubbers or copolymers of dienes and of α-olefins of EPDM type do not fall under the preceding definition and may especially be described as “essentially saturated” diene elastomers (low or very low content, always less than 15%, of units of diene origin). In the category of “essentially unsaturated” diene elastomers, “highly unsaturated” diene elastomer is understood in particular to mean a diene elastomer having a content of units of diene origin (conjugated dienes) which is greater than 50%.

Diene elastomer capable of being used in the compositions in accordance with the invention is understood more particularly to mean:
(a) any homopolymer of a conjugated diene monomer, especially any homopolymer obtained by polymerization of a conjugated diene monomer having from 4 to 12 carbon atoms;
b) any copolymer obtained by copolymerization of one or more conjugated dienes with one another or with one or more vinylaromatic compounds having from 8 to 20 carbon atoms;
c) a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
d) a copolymer of isobutene and of isoprene (butyl rubber) and also the halogenated versions, in particular chlorinated or brominated versions, of this type of copolymer.

Although it applies to any type of diene elastomer, those skilled in the art of tyres will understand that the present invention is preferably employed with essentially unsaturated diene elastomers, in particular of the type (a) or (b) above. In the case of copolymers of the type (b), the latter contain from 20% to 99% by weight of diene units and from 1% to 80% by weight of vinylaromatic units.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene.

The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

“Isoprene elastomer” is understood to mean, in a known way, an isoprene homopolymer or copolymer, in other words a diene elastomer selected from the group consisting of natural rubber (NR), synthetic polyisoprenes (IRs), various isoprene copolymers and the mixtures of these elastomers. Mention will in particular be made, among isoprene copolymers, of isobutene/isoprene (butyl rubber—IIR), isoprene/styrene (SIR), isoprene/butadiene (BIR) or isoprene/butadiene/styrene (SBIR) copolymers. This isoprene elastomer is preferably natural rubber or a synthetic cis-1,4-polyisoprene, preferably natural rubber. For example, the synthetic polyisoprene can be a polyisoprene having a content (mol %) of cis-1,4- bonds of greater than 90%, more preferentially still of greater than 98%.

The elastomers used in the context of the present invention can, for example, be block, random, sequential or microsequential elastomers and can be prepared in dispersion or in solution; they can be coupled and/or star-branched and/or functionalized with a coupling and/or star-branching and/or functionalization agent.

The isoprene elastomer can be selected from the group consisting of natural rubber, synthetic polyisoprene and their mixture. Preferably, the isoprene elastomer is natural rubber.

For the purposes of the present invention, copolymer of butadiene units and of styrene units refers to any copolymer obtained by copolymerization of one or more butadiene(s) with one or more styrene compounds. The following, for example, are suitable as styrene compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene. These elastomers can have any microstructure, which depends on the polymerization conditions used, especially on the presence or absence of a modifying and/or randomizing agent and on the amounts of modifying and/or randomizing agent employed. The elastomers can, for example, be block, random, sequential or microsequential elastomers and can be prepared in dispersion or in solution.

The butadiene and styrene copolymer can, for example, be butadiene/styrene copolymer (SBR). It can, for example, concern an SBR prepared in emulsion (“ESBR”) or an SBR prepared in solution (“SSBR”). The contents of vinyl (1,2-), trans-1,4- and cis-1,4- bonds of the butadiene part of the SBR can be variable. For example, the vinyl content can be between 15% and 80% (mol %) and the content of trans-1,4- bonds between 15% and 80% (mol %).

The diene elastomer can also predominantly, indeed even exclusively, comprise a polybutadiene.

The following are suitable: polybutadienes and in particular those having a content (mol %) of 1,2- units of between 4% and 80% or those having a content (mol %) of cis-1,4- units of greater than 80%, polyisoprenes, butadiene/styrene copolymers and in particular those having a Tg (glass transition temperature Tg, measured according to ASTM D3418) of between 0° C. and −70° C. and more particularly between −10° C. and −60° C., a styrene content of between 5% and 60% by weight and more particularly between 20% and 50%, a content (mol %) of 1,2- bonds of the butadiene part of between 4% and 75% and a content (mol %) of trans-1,4- bonds of between 10% and 80%, butadiene/isoprene copolymers and especially those having an isoprene content of between 5% and 90% by weight and a Tg of −40° C. to −80° C., or isoprene/styrene copolymers and especially those having a styrene content of between 5% and 50% by weight and a Tg of between −5° C. and −50° C. In the case of butadiene/styrene/isoprene copolymers, those having a styrene content of between 5% and 50% by weight and more particularly of between 10% and 40%, an isoprene content of between 15% and 60% by weight and more particularly of between 20% and 50%, a butadiene content of between 5% and 50% by weight and more particularly of between 20% and 40%, a content (mol %) of 1,2- units of the butadiene part of between 4% and 85%, a content (mol %) of trans-1,4- units of the butadiene part of between 6% and 80%, a content (mol %) of 1,2- plus 3,4- units of the isoprene part of between 5% and 70% and a content (mol %) of trans-1,4- units of the isoprene part of between 10% and 50%, and more generally any butadiene/styrene/isoprene copolymer having a Tg of between −5° C. and −70° C., are especially suitable.

Crosslinking System of the Composition Having a Low Stiffness Modulus

The crosslinking system of the composition having a low stiffness modulus can be based on sulfur and/or on sulfur donors and/or on peroxide and/or on bismaleimides. The crosslinking system is preferentially a vulcanization system, i.e. a system based on sulfur (and/or on a sulfur-donating agent) and on a primary vulcanization accelerator. To this base vulcanization system, various known secondary vulcanization accelerators or vulcanization activators are added, such as zinc oxide, stearic acid or equivalent compounds, or guanidine derivatives (in particular diphenylguanidine), or else known vulcanization retarders, which are incorporated during the first non-productive phase and/or during the productive phase, as described subsequently.

The crosslinking system, preferably sulfur, may be used at a preferential content of between 0.1 and 5 phr, in particular between 0.1 and 2 phr, further preferably between 0.5 and 1.5 phr.

Reinforcing Filler of the Composition Having a Low Stiffness Modulus

The reinforcing filler is known for its abilities to reinforce a rubber composition which can be used in the manufacture of tyres.

According to the invention, the reinforcing filler of the composition having a low stiffness modulus can comprise carbon black, an organic filler other than carbon black, an inorganic filler or the mixture of at least two of these fillers. Preferentially, the reinforcing filler can predominantly comprise, indeed even exclusively comprise, carbon black. The reinforcing filler can also predominantly comprise, indeed even exclusively comprise, a reinforcing inorganic filler.

Such a reinforcing filler typically consists of nanoparticles, the (weight-)average size of which is less than a micrometre, generally less than 500 nm, most commonly between 20 and 200 nm, in particular and more preferentially between 20 and 150 nm.

The carbon black has a BET specific surface area preferably of at least 90 m²/g, more preferentially of at least 100 m²/g. The blacks conventionally used in tyres or their treads (“tyre-grade” blacks) are suitable in this regard. Among the latter, mention will more particularly be made of the reinforcing carbon blacks of the 100, 200 and 300 series, or the blacks of the 500, 600 or 700 series (ASTM grades), such as, for example, the N115, N134, N234, N326, N330, N339, N347, N375, N550, N683 and N772 blacks. These carbon blacks can be used in the isolated state, as commercially available, or in any other form, for example as support for some of the rubber additives used. The carbon blacks might, for example, be already incorporated in the diene elastomer, especially isoprene elastomer, in the form of a masterbatch (see, for example, Applications WO 97/36724 and WO 99/16600). The BET specific surface area of the carbon blacks is measured according to Standard D6556-10 [multipoint (at least 5 points) method—gas: nitrogen—relative pressure p/p₀ range: 0.1 to 0.3].

Mention may be made, as examples of organic fillers other than carbon blacks, of functionalized polyvinyl organic fillers, such as described in Applications WO 2006/069792, WO 2006/069793, WO 2008/003434 and WO 2008/003435.

The term “reinforcing inorganic filler” should be understood here to mean any inorganic or mineral filler, regardless of its colour and its origin (natural or synthetic), also known as “white filler”, “clear filler” or even “non-black filler”, in contrast to carbon black, capable of reinforcing, by itself alone, without means other than an intermediate coupling agent, a rubber composition intended for the manufacture of pneumatic tyres, in other words capable of replacing, in its reinforcing role, a conventional tyre-grade carbon black; such a filler is generally characterized, in a known way, by the presence of hydroxyl (—OH) groups at its surface.

Mineral fillers of the siliceous type, preferentially silica (SiO₂), are especially suitable as reinforcing inorganic fillers. The silica used can be any reinforcing silica known to those skilled in the art, especially any precipitated or fumed silica exhibiting a BET surface area and also a CTAB specific surface area both of less than 450 m²/g, preferably from 30 to 400 m²/g, especially between 60 and 300 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in Application WO 03/016387.

In the present account, as regards the silica, the BET specific surface area is determined in a known way by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method—gas: nitrogen—degassing: 1 hour at 160° C.—relative pressure p/p₀ range: 0.05 to 0.17). The CTAB specific surface area is the external surface area determined according to French Standard NFT 45-007 of November 1987 (method B).

Mineral fillers of the aluminous type, in particular alumina (Al₂O₃) or aluminum (oxide) hydroxides, or else reinforcing titanium oxides, for example described in U.S. Pat. No. 6,610,261 and U.S. Pat. No. 6,747,087, are also suitable as reinforcing inorganic fillers.

The physical state in which the reinforcing inorganic filler is provided is not important, whether it is in the form of a powder, of microbeads, of granules, of beads or any other appropriate densified form. Of course, the term “reinforcing inorganic filler” is also understood to mean mixtures of different reinforcing inorganic fillers, in particular of highly dispersible siliceous and/or aluminous fillers as described above.

In order to couple the reinforcing inorganic filler to the diene elastomer, use is made, in a well-known way, of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional.

The content of coupling agent is advantageously less than 12 phr, it being understood that it is generally desirable to use as little as possible of it. Typically, the content of coupling agent represents from 0.5% to 15% by weight relative to the amount of inorganic filler. Its content is preferentially between 0.5 and 9 phr, more preferentially within a range extending from 3 to 9 phr. This content is easily adjusted by those skilled in the art depending on the content of inorganic filler used in the composition.

According to the invention, the content of reinforcing filler may be within a range extending from 10 to 160 phr, preferably from 10 to 150 phr, preferably from 10 to 90 phr, preferably from 20 to 70 phr, preferably from 25 to 60 phr.

Advantageously, the content of reinforcing filler is within a range extending from 10 to 30% of the fraction by volume, preferably from 15 to 25% of the fraction by volume, relative to the volume of the composition having a low stiffness modulus.

Various Additives of the Composition Having a Low Stiffness Modulus

The composition having a low stiffness modulus may also comprise all or a portion of the usual additives customarily used in elastomer compositions intended to constitute treads, such as, for example, plasticizers, fibres, pigments, protective agents, such as antiozone waxes, chemical antiozonants, antioxidants, or antifatigue agents, well known to those skilled in the art.

Advantageously, in order not to raise the modulus of extension at 5% deformation thereof, the composition having a low stiffness modulus does not comprise reinforcing resin and/or reinforcing fibres.

Composition Having a High Stiffness Modulus

According to the invention, the tread consists of a plurality of layers comprising layers formed by a composition having a high stiffness modulus. “Composition having a high stiffness modulus” is intended to mean a composition, the modulus of extension at 5% deformation of which is within a range extending from 30 MPa to 50 GPa. Preferably, the modulus of extension at 5% deformation of the composition having a high stiffness modulus is within a range extending from 30 to 300 MPa, preferably from 40 to 200 MPa.

As indicated above, those skilled in the art can measure the stiffness, the modulus of extension at 5% deformation of which according to a method based on standard NF ISO 37 of December 2005 on a type 2 dumbbell test specimen and measure the elastic modulus at 5% deformation at 23° C.

Those skilled in the art have several means at their disposal in order to obtain a composition having a high stiffness modulus. For example, those skilled in the art may use high contents of reinforcing filler and/or crosslinking system and/or reinforcing fibres, for example in an elastomeric matrix. They may also, alternatively or additionally, use thermoplastic materials or thermoplastic elastomers.

Thus, according to a first embodiment of the invention, the composition having a high stiffness modulus may be an elastomeric composition based on an elastomeric matrix, at least one reinforcing filler and at least one crosslinking system. The composition having a high stiffness modulus may also be a thermoplastic or comprise a thermoplastic elastomer.

When the composition having a high stiffness modulus is an elastomeric composition based on an elastomeric matrix, at least one reinforcing filler and at least one crosslinking system, the elastomeric matrix, the reinforcing filler and the crosslinking system may be identical to those of the composition having a low stiffness modulus. In particular:
the elastomeric matrix of the composition having a high stiffness modulus may comprise a diene elastomer, preferably an elastomer selected from isoprene elastomers, butadiene and styrene copolymers, polybutadienes and mixtures thereof.
the reinforcing filler of the composition having a high stiffness modulus may comprise carbon black and/or a reinforcing inorganic filler; preferably, the reinforcing filler predominantly comprises carbon black,
the crosslinking system of the composition having a high stiffness modulus may comprise a crosslinking agent selected from the group consisting of sulfur, a sulfur donor, a peroxide, a bismaleimide, and the mixture of at least two of these crosslinking agents.

The content of reinforcing filler of the composition having a high stiffness modulus may generally be within a range extending from 10 to 160 phr, preferably from 10 to 150 phr, preferably from 10 to 90 phr, preferably from 20 to 70 phr, preferably from 25 to 60 phr.

Advantageously, the content of reinforcing filler of the composition having a high stiffness modulus is within a range extending from 1 to 50% of the fraction by volume, preferably from 10 to 40%, preferably from 15 to 25% of the fraction by volume, relative to the volume of the composition having a high stiffness modulus.

If those skilled in the art wish to obtain a modulus of extension at 5% deformation of greater than 30 MPa by virtue of the content of reinforcing filler, the content of reinforcing filler may be within a range extending from 25 to 50% of the fraction by volume, preferably from 40 to 50% of the fraction by volume, relative to the volume of the composition having a high stiffness modulus.

Moreover, the crosslinking system of the composition having a high stiffness modulus, preferably sulfur, may be used at a preferential content of between 0.1 and 40 phr, preferably between 0.1 and 20 phr, in particular between 0.1 and 10 phr, further preferably between 0.5 and 10 phr.

If those skilled in the art wish to obtain a modulus of extension at 5% deformation of greater than 30 MPa by virtue of the content of crosslinking system, the content of crosslinking system may be between 20 and 40 phr, preferably between 30 and 40 phr.

Alternatively, or additionally, according to this first embodiment of the invention, the composition having a high stiffness modulus may comprise a reinforcing resin.

The reinforcing resin may for example be a resin selected from polyepoxide resins, melamine/formaldehyde resins, phenol/formaldehyde resins, urea/formaldehyde resins, polyurethane resins, unsaturated polyester resins, vinyl ester resins, polyimide resins, diallyl phthalate resins, allyl diglycol carbonate resins and polyorganosiloxane resins, preferably from phenol/formaldehyde resins or epoxy resins, the latter being especially able to be used as adhesion primer.

Preferably, the reinforcing resin may be a resin selected from melamine/formaldehyde resin, phenol/formaldehyde resin or urea/formaldehyde resin, and even more preferentially phenol/formaldehyde resin.

As example of commercially available resin, mention may be made, for example, of the Alnovol PN-320 phenol/formaldehyde resin from Allnex, 1070 Anderlecht—Brussels, Belgium, or the Technic RR-110 phenol/formaldehyde resin from Techno Waxchem Pvt Ltd Kolkata 700046, WB, India.

Advantageously, the reinforcing resin may contain an activator which enables the crosslinking of the resin. For example, the activator may be selected from hexamethylenetetramine (HMTA) with, especially, Technic-SCH from Techno Waxchem Pvt. Ltd. Kolkata 700046, WB, India, or hexa(methoxymethyl)melamine (H3M), with, especially, Cyrez CRA100 from Allnex, 1070 Anderlecht—Brussels, Belgium.

According to a second embodiment of the invention, the composition having a high stiffness modulus may be a thermoplastic.

The thermoplastic preferentially has a melting or softening point of greater than 100° C., preferentially greater than 140° C. and very preferentially of between 170 and 300° C. The softening point may be measured, for example, according to the method described in standard ASTM D 1525.

Preferentially, the thermoplastic is selected from the group consisting of polyolefins, vinyl chloride polymers, polystyrenes, polyamides, polyesters, ethylene/vinyl alcohol (EVOH) copolymers, polyacrylates, polyacetals and mixtures thereof.

Preferably, the polyolefins are selected from polyethylenes and polypropylenes.

Preferably, the vinyl chloride polymers are selected from polyvinyl chlorides (PVCs), polyvinylidene chlorides (PVDCs), chlorinated polyvinyl chlorides (CPVCs), and mixtures thereof.

Preferably, the polyesters are selected from polyethylene terephthalates (PETs), polybutylene terephthalates (PBTs), polycarbonates (PCs) and polyethylene naphthalates (PENs), and mixtures thereof.

The polyamides may be selected from aliphatic polyamides and preferably from polyamides 6, polyamides 6-6, polyamides 11, and mixtures thereof.

An example of polyacrylate is polymethyl methacrylate (PMMA); an example of polyacetal is polyoxymethylene (POM).

The thermoplastics are commercially available, sold for example, as regards the polyamides, as PA11 Rilsan from Arkema, PA12 Grilamid from EMS-Grimory, PA6 Trogamid from Evonik, PA12 Orgasol from Arkema. They have for example been described, along with their synthesis, in the documents “Techniques de l'ingénieur” [The Engineer's Techniques], ref A3360 and 0702 polyamides PA, which reference originates from “matáriaux plastiques et composites” [Plastic and composite materials] by B. Guerin.

Advantageously, according to the invention, the thermoplastic may be rendered adhesive, that is to say treated so as to improve the adhesion thereof to the layers comprising a composition having a low stiffness modulus. For example, the thermoplastic may be rendered adhesive with an adhesive selected from epoxy adhesives, followed by a treatment with liquid resorcinol/formaldehyde latex (RFL), and formaldehyde-based adhesives, preferably RFL adhesives. As example of RFL adhesive of use for rendering the thermoplastic adhesive, mention may be made of those described in application WO 2001/057116.

According to a third embodiment of the invention, the composition having a high stiffness modulus may comprise a thermoplastic elastomer (TPE).

According to this embodiment, the composition having a high stiffness modulus comprises at least, as sole elastomer or predominant elastomer by weight, a thermoplastic elastomer.

TPEs have a structure intermediate between thermoplastic polymers and elastomers. They consist of rigid thermoplastic sequences connected by flexible elastomer sequences, for example polybutadiene, polyisoprene, poly(ethylene/butylene) or else polyisobutylene. They are often triblock elastomers with two rigid segments connected by a flexible segment. The rigid and flexible segments can be positioned linearly, in a star or branched configuration. Typically, each of these segments or blocks contains at least more than 5, generally more than 10, base units (for example, styrene units and isoprene units for a styrene/isoprene/styrene triblock copolymer).

The thermoplastic elastomer may be selected from the group consisting of thermoplastic styrene elastomers (TPSs), polyether block amide (PEBA) copolymers, copolyesters (COPEs), thermoplastic polyurethane elastomers (TPUs), vulcanized thermoplastics (TPVs), thermoplastic polyolefins (TPOs) and the mixture of these TPEs. Advantageously, the thermoplastic elastomer is a TPS elastomer.

As example of TPS elastomer, mention may be made of the following copolymers: styrene/butadiene/styrene (SBS), styrene/isoprene/styrene (SIS), styrene/ethylene/butylene/styrene (SEBS), styrene/isoprene/butylene/styrene (SIBS), styrene/ethylene/propylene/styrene (SEPS) and ii) less than 90% by weight, preferably from 0% to 80% of one or more diblock copolymers of styrene/butadiene (SB) or styrene/isoprene (SI) or styrene/ethylene/butylene (SEB) or styrene/isoprene/butylene (SIB) or styrene/ethylene/propylene (SEP) type.

It is preferred for the glass transition temperature (Tg, measured according to ASTM D3418) of the elastomeric block of the TPE elastomer to be less than −20° C., more preferentially less than −40° C.

The number-average molecular weight (denoted by Mn) of the TPE elastomer is preferentially between 30 000 and 500 000 g/mol, more preferentially between 40 000 and 400 000 g/mol. The number-average molecular weight (Mn) of the TPS elastomer is determined, in a known way, by size exclusion chromatography (SEC). The sample is dissolved beforehand in tetrahydrofuran at a concentration of approximately 1 g/l and then the solution is filtered through a filter with a porosity of 0.45 μm before injection.

The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel tradenames (HMW7, HMW6E and two HT6Es), is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards.

The polydispersity index PI (reminder: PI=Mw/Mn, with Mw the weight-average molecular weight) of the TPS elastomer is preferably less than 3; more preferentially, PI is less than 2.

According to the third embodiment of the present invention, the TPE elastomer may be the sole elastomer of the composition having a high stiffness modulus, or else be combined with other elastomers.

If optional other elastomers are used in the composition having a high stiffness modulus, the TPE elastomer constitutes the predominant elastomer by weight. Such additional elastomers, minor by weight, could for example be diene elastomers such as natural rubber or a synthetic polyisoprene, a butyl rubber or thermoplastic elastomers other than styrene elastomers, as long as their microstructures are compatible. Preferably, the elastomer other than the thermoplastic elastomer is selected from the group consisting of polybutadienes, synthetic polyisoprenes, natural rubber, butadiene copolymers, isoprene copolymers and the mixtures of these elastomers.

Thus, the composition having a high stiffness modulus may comprise from 50 to less than 100 phr, preferably from 70 to less than 100 phr, preferably from 80 to less than 100 phr, preferably from 90 to less than 100 phr, of TPE. In this case, the composition having a high stiffness modulus comprises from more than 0 to 50 phr, preferably from more than 0 to 30 phr, preferably from more than 0 to 20 phr, preferably from 0 to 10 phr, of another elastomer other than the TPE.

Nonetheless, according to a particular embodiment, the thermoplastic elastomer is the sole thermoplastic elastomer, advantageously the sole elastomer, present in the composition having a high stiffness modulus. In other words, advantageously, the composition having a high stiffness modulus comprises exclusively, that is to say 100 phr of, TPE.

The TPE elastomers may be processed in the conventional way, by extrusion or moulding, for example using a starting material available in the form of beads or granules.

The TPE elastomers are commercially available, sold for example, as regards the SIBSs, by Kaneka under the name Sibstar (e.g. Sibstar 102T, Sibstar 103T or Sibstar 073T). They have, for example, been described, along with their synthesis, in the patent documents EP 731 112, U.S. Pat. No. 4,946,899 and U.S. Pat. No. 5,260,383. They were developed, first of all, for biomedical applications and then described in various applications specific to TPEs, especially to TPS elastomers, as varied as medical equipment, parts for motor vehicles or for domestic electrical appliances, sheathing for electric wires, leaktightness parts or elastic parts (see, for example, EP 1 431 343, EP 1 561 783, EP 1 566 405 and WO 2005/103146).

According to this third embodiment of the present invention, the composition having a high stiffness modulus may comprise a reinforcing filler and a crosslinking system. Preferably, the reinforcing filler and/or the crosslinking system of the composition having a high stiffness modulus according to the third embodiment are identical to those of the first embodiment of the present invention.

Tread Pattern of the Tread

The tread according to the present invention comprises a tread pattern.

According to the invention, the tread pattern of the tread consists of a plurality of parallel layers adjacent to one another, the layers being oriented within the tread pattern parallel to a plane which is (i) perpendicular to the equatorial plane and (ii) oriented at an angle α expressed in degrees relative to the radial plane, the angle α being defined by the formula α=45+/−x, in which x is within a range extending from 10 to 30. In other words, the layers are oriented within the tread pattern parallel to a plane which is (i) perpendicular to the equatorial plane and (ii) oriented at an angle α expressed in degrees relative to the radial plane, the angle α being within a range extending from 15 to 35 degrees or from 55 to 75 degrees.

Unless indicated otherwise, the orientation of the layers in the tread according to the invention is expressed relative to a tread arranged on a tyre. Those skilled in the art will know how to readily convert the orientation of the layers when the tread is arranged flat, for example in the form of a semi-finished article. In the event that the tread is arranged flat, it could be defined according to directions parallel to its length, its width and its thickness, which would correspond, respectively, to the circumferential “X”, transverse “Y” and radial “Z” directions. The circumferential plane would then be a plane defined by the length and the thickness of the tread, and the radial plane would be a plane defined by the width and the thickness of the tread.

Those skilled in the art can measure the angle of the layers within the tread by removing a part of the tread, preferentially by removing half the width of a rib along a plane parallel to the plan XoZ, so as to make an interface appear that contains the layers, and by taking a test specimen of material by cutting the tread according to FIG. 2, and by creating the histogram of orientation of the layers in the plane XOZ relative to the direction Z by optical reflection microscopy.

According to the invention, the layers may be oriented the tread pattern parallel to a plane which is (i) perpendicular to the equatorial plane and (ii) oriented at an angle α expressed in degrees relative to the radial plane, the angle α being defined by the formula α=45+/−x, in which x is within a range extending from 12.5 to 27.5 (that is to say from 17.5 to 35.5 degrees or from 57.5 to 72.5 degrees), preferably from 15 to 25 (that is to say from 20 to 30 degrees or from 60 to 70 degrees); preferably, x is equal to 20 (that is to say 25 degrees or 65 degrees). Unless indicated otherwise, the angle α is expressed as an absolute value.

Those skilled in the art understand well that when reference is made to layers oriented according to the same angle α, this may be layers having substantially the same angle α, that is to say that the layers are oriented according to an angle α with a low standard deviation, for example a standard deviation of 3 degrees, or even less, over at least 80% of the surface of the plane XoZ.

Regardless of the value of the angle α in the range of α=45+/−10 to 30 degrees, this orientation gives the composite material the ability to transfer a portion of the component Fz of the ground forces on the tyre to the component Fx, that is to say from the vertical component to the horizontal component in the direction of running of the tyre. This level of coupling is particularly advantageous for improving the wear resistance of tyres for civil engineering vehicles, especially in their specific conditions of use.

Depending on the angle of the layers within the tread pattern, the level of coupling is not the same. Thus, when the angle α is between 15 and 35 degrees (that is to say α=45−from 10 to 30), the tread pattern will transform the component Fz into a positive component Fx. It may be noted that the closer the angle α is to 25 degrees, the higher is the level of coupling. This embodiment is particularly advantageous for improving the wear resistance of tyres for vehicles bearing heavy loads uphill.

Moreover, when the angle α is between 55 and 75 degrees (that is to say α=45+from 10 to 30), the tread pattern will transform the component Fz into a negative component Fx. The closer the angle α is to 65 degrees, the higher is the level of coupling. This embodiment is particularly advantageous for improving the wear resistance of tyres for vehicles running empty downhill.

When the angle α is between 35 and 55 degrees, the level of coupling becomes too low, or even zero at around 45 degrees, to give the desired property to the tread pattern of the tread according to the invention. The same applies when the angle α is less than 15 degrees or greater than 75 degrees.

According to the invention, the plurality of layers comprises layers formed by a composition having a low stiffness modulus and layers formed by a composition having a high stiffness modulus.

More particularly, the plurality of layers comprises at least one (that is to say one or more) group of layers formed by a composition having a low stiffness modulus and at least one (that is to say one or more) group of layers formed by a composition having a high stiffness modulus.

In the present document, “a group of layers” is intended to mean one or more layers identical to one another. In other words, when the plurality of layers comprises several groups of different layers, these layers may differ from one another by the nature of the elastomeric matrix, of the thermoplastic or of the thermoplastic elastomer, the nature or the concentration of reinforcing filler, the nature or the concentration of reinforcing resin, the crosslinking system, the additives, etc.

Thus, the plurality of layers is formed by at least two groups of different layers, or even more, for example three, four or five groups of layers that are different from one another. Advantageously, the plurality of layers is formed of two groups of different layers, that is to say by one group of layers formed by a composition having a low stiffness modulus and one group of layers formed by a composition having a high stiffness modulus, preferably arranged alternately.

Any distribution of layers formed by a composition having a low stiffness modulus and layers formed by a composition having a high stiffness modulus may be implemented. For example, the layers may or may not be distributed alternately. For example, when the plurality of layers comprises two groups of different layers (for example referred to as A and B, respectively), the distribution may follow the following formula:

((A)_{nA}(B)_{nB}),

in which:
“nA” and “nB” represent, independently of one another, an integer chosen from 1 to 10, preferably from 1 to 5, preferably from 1 to 2, preferably 1.

When the composite material comprises more than two groups of different layers (for example referred to as A, B, . . . , X, respectively), the distribution may follow the following formula:

((A)_{nA}(B)_{nB}( . . . )_{n . . .} (X)_{nX}),

in which:
“nA”, “nB”, “n . . . ” and “nX” represent, independently of one another, an integer chosen from 1 to 10, preferably from 1 to 5, preferably from 1 to 2, preferably 1.

The total number of layers within the tread pattern is limited by the length of the tread. Those skilled in the art are able to determine this number as a function of the thickness of the layers and of their orientation within the tread pattern.

Preferably, according to the invention, the tread pattern of the tread is formed by a group of layers formed by a composition having a low stiffness modulus and a group of layers formed of a composition having a high stiffness modulus, distributed alternately within the tread pattern of the tread (FIG. 2).

Advantageously, the composition having a low stiffness modulus has a stiffness at extension which is at least 5 times less, preferably at least 10 times less, than that of the composition having a high stiffness modulus. Those skilled in the art are able to determine how to measure the stiffness at extension of the compositions having low and high stiffness moduli. For example, they may use a method based on standard NF ISO 37 of December 2005 on a type 2 dumbbell test specimen and measure the elastic modulus at 5% deformation at 23° C.

Advantageously, the modulus E_{H}, and the fraction by volume ϕH of the composition having a high modulus, and the modulus E_{B}, and the fraction by volume ϕB (or 1−ϕH) of the composition having a low modulus, are defined such that the formula

$$\frac{α}{[ φ H + ( 1 - φ H ) α ] [ φ H α + ( 1 - φ H ) ]} , in which α = {E}_{H} / {E}_{M} ,$$

is less than 0.67, preferably between 0.01 and 0.5.

The thickness of each of the layers formed by a composition having a low stiffness modulus may be within a range extending from 1 to 20 mm, preferably from 1 to 10 mm.

The thickness of each of the layers formed by a composition having a high stiffness modulus may be within a range extending from 0.1 to 20 mm, preferably from 0.1 to 10 mm. Preferentially, when the composition having a high stiffness modulus is a thermoplastic, the thickness of each of the layers may be within a range extending from 0.1 to 5 mm, preferably from 0.1 to 2 mm. When the composition having a high stiffness modulus comprises an elastomeric matrix, or even a thermoplastic elastomer, the thickness of each of the layers may be within a range extending from 0.1 to 20 mm, preferably from 0.1 to 10 mm.

Advantageously, the volume of the layers of the composition having a low stiffness modulus may represent from 50 to 95% by volume, preferably from 60 to 95% by volume, relative to the volume of the tread pattern of the tread. Thus, the volume of the layers of the composition having a high stiffness modulus may represent respectively from 5 to 50% by volume, preferably from 5 to 40% by volume, relative to the volume of the tread pattern of the tread.

Tyres

The present invention may be applied to any type of tyre. Thus, another subject of the present invention is a tyre comprising a tread according to the invention.

Generally, a tyre comprises a tread intended to come into contact with the ground via a tread surface and connected via two sidewalls to two beads, the two beads being intended to provide a mechanical connection between the tyre and the rim on which the tyre is fitted.

A radial tyre more particularly comprises a reinforcement comprising a crown reinforcement radially internal to the tread and a carcass reinforcement radially internal to the crown reinforcement.

A tyre may be provided with a carcass reinforcement surmounted radially on the outside by a crown reinforcement in order to produce hooping of said carcass reinforcement. The crown reinforcement is generally formed by a stack of a plurality of reinforcing plies, these reinforcers forming generally non-zero angles with the circumferential direction.

A tyre especially comprises a tread, the tread surface of which is provided with a tread pattern formed by a plurality of grooves delimiting elements in relief (tread blocks, ribs) so as to generate material edge corners and also voids. These grooves represent a volume of voids which, related to the total volume of the tread (including both the volume of elements in relief and that of all the grooves), is expressed by a percentage denoted, in the present document, by “volumetric void ratio”. A volumetric void ratio equal to zero indicates a tread without grooves or voids.

The present invention is particularly well suited to tyres intended for civil engineering vehicles and to heavy-duty vehicles, more particularly to civil engineering vehicles, the tyres of which are subjected to particularly specific stresses. Thus, advantageously, the tyre according to the invention is a tyre for civil engineering or heavy duty vehicles, preferably civil engineering vehicles.

The tread according to the invention may have one or more grooves, the mean depth of which ranges from 15 to 120 mm, preferably 65 to 120 mm.

The tyres according to the invention may have a diameter ranging from 20 to 63 inches, preferably from 35 to 63 inches.

Moreover, the mean volumetric void ratio over the whole of the tread according to the invention may be within a range extending from 5 to 40%, preferably of from 5 to 25%.

Preparation of the Composition Having a Low Stiffness Modulus

The tread patterns of the tread may be obtained according to the process defined below.

The masterbatches (mixtures containing all the ingredients with the exception of the crosslinking system) can be manufactured in appropriate mixers, using two successive preparation phases according to a general procedure well known to those skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically of less than 110° C., for example between 40° C. and 100° C., during which finishing phase the chemical crosslinking agent, in particular the crosslinking system, is incorporated.

By way of example, in order to obtain the masterbatches, the first (non-productive) phase is carried out in a single thermomechanical step during which all the necessary constituents, the optional additional covering agents or processing aids and various other additives, with the exception of the vulcanization system, are introduced into an appropriate mixer, such as an ordinary internal mixer. The total duration of the kneading, in this non-productive phase, is preferably between 2 and 10 min. After cooling the mixture thus obtained during the first non-productive phase, the vulcanization system is then incorporated at low temperature, generally in an external mixer, such as an open mill; everything is then mixed (productive phase) for a few minutes, for example between 5 and 15 min.

The tread pattern composition thus obtained is subsequently calendered, for example in the form of a layer.

Preparation of the Composition Having a High Stiffness Modulus

When the composition having a high stiffness modulus is an elastomeric composition based on an elastomeric matrix, at least one reinforcing filler and at least one crosslinking system, or when it comprises a thermoplastic elastomer, this composition may be prepared according to a process that is similar or identical to that of the composition having a low stiffness modulus.

When the composition having a high stiffness modulus is a thermoplastic, it may be produced in suitable mixers according to processes that are well known to those skilled in the art. For example, in a first step, the thermoplastic material, generally in the form of granules, is introduced into a mixer and is worked or kneaded at a temperature above its softening point, in general at a temperature greater by 10° C. than the melting point or the glass transition temperature of the thermoplastic.

In a second step, the thermoplastic material is cooled to a temperature below its softening point, and extruded or calendered in the form of a sheet or slab which is subsequently cut so as to obtain elements on the centimetre scale of desired forms and dimensions.

Preparation of the Tread

In order to obtain the desired orientation of the layers in the tread according to the present invention, use may be made of any technique well known to those skilled in the art, especially the process described in application WO 2008/027045. For example, layers of composition having low and high stiffness moduli may be assembled flat, alternately, and cut by any suitable means, for example by water jet cutting, at the desired angle, so as to form tread pattern elements that may be arranged on an uncured tyre in a manner well known to those skilled in the art.

Other advantages may yet become apparent to those skilled in the art on reading the examples below, which are illustrated by the appended figures and which are given by way of illustration and without limitation.

### BRIEF DESCRIPTION OF THE FIGURES

FIG. 1 is a schematic depiction of a tyre (1), the tread of which comprises a rib (2) located in the central zone of the tyre (1), and tread blocks (3), the rib and the tread blocks being separated by circumferential grooves (4) and substantially transverse grooves (5).

FIG. 2 is a schematic depiction of several embodiments of a tread pattern according to the invention, viewed in section along the plane XZ. This tread pattern is composed of a plurality of layers (c1) formed of a composition having a high stiffness modulus (thinner) and of layers (c2) formed of a composition having a low stiffness modulus (thicker), which are parallel and adjacent to one another and are oriented parallel to a plane which is (i) perpendicular to the plane XZ and (ii) oriented at an angle (a) of 20 degrees for E1 and E3, of 25 degrees for E4 and of 30 degrees for E2, relative to the plane YZ.

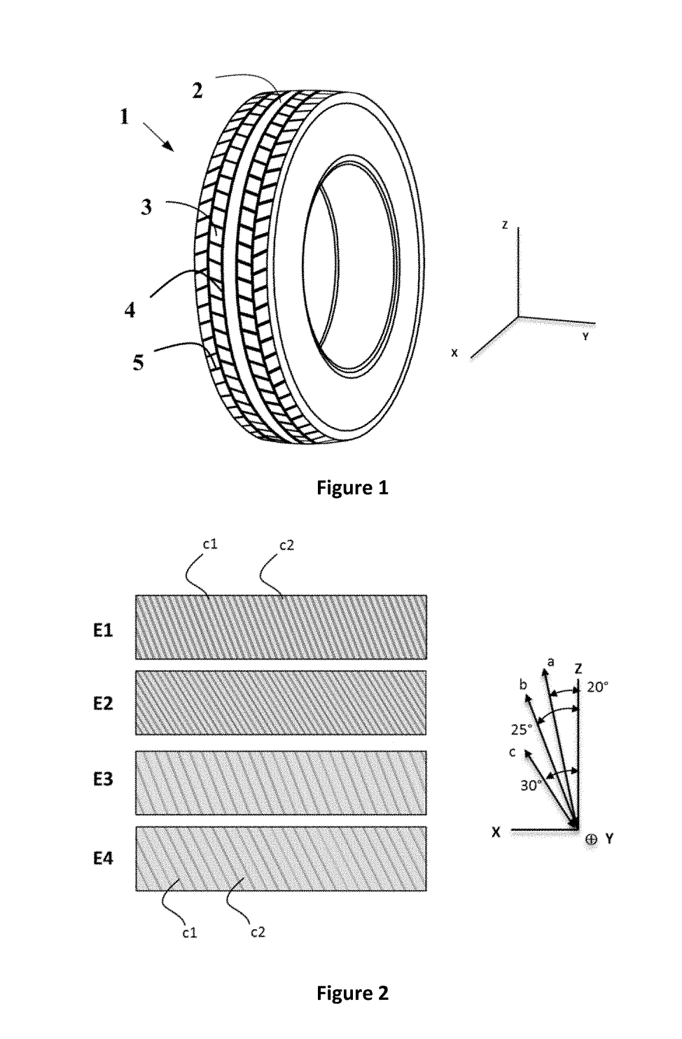

### EXAMPLES

A) Samples with 10 cm×10 cm surface area and 3 cm thickness were produced according to the process described in application WO 2008/027045 with layers formed by compositions having low and high stiffness moduli arranged alternately.

The following definitions apply:
“X”: a direction parallel to the direction of stress loading of the sample, itself parallel to the length of the sample.
“Y”: a direction parallel to the width of the sample.
“Z”: a direction parallel to the thickness of the sample.

A composition A, which is a composition having a low stiffness modulus, and a composition B, which is a composition having a high stiffness modulus, were prepared. These composition and the associated experimental results are presented in table 1 below:

TABLE 1

| | A | B |
|---|---|---|
| NR (1) | 100 | 100 |
| Silica (2) | 15 | |
| Carbon black (3) | 40 | |
| Carbon black (4) | | 75 |
| ZnO (5) | 3 | 8 |
| Stearic acid | 1 | 1 |
| PEG (6) | 2.5 | |
| FP resin (7) | | 11 |
| HTT3H (8) | | 3 |
| H3M72 (9) | | 6 |
| Sulfur | 2 | 5 |
| Accelerator (10) | 1.7 | |
| Accelerator (11) | | 1 |
| Antioxidant (12) | 1 | 1.5 |
| Modulus of extension (a) | 4.7 MPa | 54 MPa |

(1) Natural rubber
(2) Ultrasil VN3, sold by Evonik
(3) Carbon black of N234 grade according to Standard ASTM D-1765
(4) Carbon black of N330 grade according to Standard ASTM D-1765
(5) Zinc oxide of industrial grade from Umicore
(6) Polyethylene glycol with an Mn of 6000-20 000 g/mol, sold by Sasol Marl
(7) Phenol/formaldehyde resin
(8) Hexamethylenetetramine hardener
(9) Hexa(methoxymethyl)melamine hardener
(10) N-cyclohexyl-2-benzothiazolesulfenamide, Santocure CBS, sold by Flexsys
(11) N-tert-butyl-2-benzothiazolesulfenamide, sold under the name TBBS
(12) N-(1,3-dimethylbutyl)-N′-phenyl-p-phenylenediamine, sold under the name 6PPD
(a) Elastic modulus at 5% deformation

Samples E1, E2, E3 and E4 were produced from compositions A and B in the form of layers arranged alternately and parallel to a plane defined by (i) the direction Y and (ii) a straight line oriented at 20, 25 or 30 degrees relative to the direction Z in a plane defined by the directions X and Z.

A control sample R1 was produced solely with a composition A, without using oriented layers.

The mechanical properties were measured after curing the abovementioned compositions at a temperature of 150° C. for 30 minutes. The results were obtained from type 2 dumbbell test specimens at 5% deformation, at 23° C. according to standard NF ISO 37 of December 2005.

In order to analyse the transfer of ground forces on the test specimen, from the vertical component (Fz) to the horizontal component in the running direction (Fx) (the level of coupling), a force Fz of 900 daN, corresponding to a mean pressure of 9 bar, or of 600 daN, corresponding to a mean pressure of 6 bar, was applied to the surface of the samples using an electric actuating cylinder and the resulting force Fx was measured using a force sensor. The ratio of Fx divided by Fz is referred to as the level of coupling and is measured at two different mean pressures.

The samples R1, E1, E2, E3 and E4 and the associated experimental results are presented in table 2 below:

TABLE 2

| Samples | R1 | E1 | E2 | E3 | E4 |
|---|---|---|---|---|---|
| Angles of the layers | * | 20 | 30 | 20 | 25 |
| (degrees) | | | | | |
| Thickness of the layers A and B | * | 2/0.5 | 2/0.5 | 4/0.5 | 4/0.5 |
| (mm) | | | | | |
| Volume of composition B | 0% | 20% | 20% | 11% | 11% |
| (% vol) | | | | | |
| Level of coupling under a mean | 0.0% | 5.7% | 8.0% | 4.0% | 5.4% |
| pressure of 6 bar | | | | | |
| Level of coupling under a mean | 0.0% | 5.7% | 4.0% | 3.8% | 3.0% |
| pressure of 9 bar | | | | | |

* not applicable

These results show that the samples in accordance with the present invention (comprising layers of composition having low and high stiffness moduli) create a level of coupling compared to a sample comprising solely a composition having a low stiffness modulus. It was observed that the samples which comprise a volume of composition B of 20% (E1 and E2) have a higher level of coupling than the samples comprising a volume of composition B of 11% (E3 and E4).

B) A similar experiment was carried out using, instead of the abovementioned composition B, a composition C (having a high stiffness modulus) made of a thermoplastic material, namely a polyamide 66 rendered adhesive with an RFL adhesive. The layers made of composition A were 2 mm thick and those of composition C were 1 mm thick. The fraction by volume of the composition C was therefore 33% relative to the volume of the test specimen.

For this experiment, the layers of compositions A and C were arranged alternately and oriented parallel to a plane defined by (i) the direction Y and (ii) a straight line oriented at 25 or 45 degrees relative to the direction Z in a plane defined by the directions X and Z.

The results observed have made it possible to demonstrate that no level of coupling is observed when the angle of the layers is 45 degrees, whereas a positive level of coupling is obtained when the angle of the layers is 25 degrees.

The various measurements carried out by the applicants have demonstrated that the level of coupling obtained was sufficient for implementing the present invention when the layers are oriented according to an angle of 15 to 35 degrees or 55 to 75 degrees.

The present invention therefore provides treads making it possible to transfer a proportion of the ground forces on the tyre from the component Fz into different components Fx, making it possible to effectively improve the wear resistance of the tyres. These results are particularly beneficial for vehicles running on non-bituminous ground, such as the majority of civil engineering vehicles and some heavy-duty vehicles.

1.-29. (canceled)

30. A tread comprising at least one tread pattern consisting of a plurality of parallel layers adjacent to one another, the layers being oriented within the tread pattern parallel to a plane which is (i) perpendicular to the equatorial plane and (ii) oriented at an angle α expressed in degrees relative to the radial plane, the angle α being defined by the formula α=45+/−x, in which x is within a range extending from 10 to 30,
wherein the plurality of parallel layers comprise (a) layers formed by a composition having a low stiffness modulus, the modulus of extension at 5% deformation of which is within a range extending from 2 to 8 MPa and (b) layers formed by a composition having a high stiffness modulus, the modulus of extension at 5% deformation of which is within a range extending from 30 MPa to 50 GPa.

31. The tread according to claim 30, wherein the composition having a low stiffness modulus is an elastomeric composition based on an elastomeric matrix, at least one reinforcing filler and at least one crosslinking system.

32. The tread according to claim 31, wherein the elastomeric matrix of the composition having a low stiffness modulus comprises a diene elastomer.

33. The tread according to claim 31, wherein the reinforcing filler of the composition having a low stiffness modulus is selected from the group consisting of carbon black, an inorganic filler, and a combination thereof.

34. The tread according to claim 31, wherein the crosslinking system of the composition having a low stiffness modulus comprises a crosslinking agent selected from the group consisting of sulfur, a sulfur donor, a peroxide, a bismaleimide, and mixtures thereof.

35. The tread according to claim 31, wherein the composition having a low stiffness modulus does not comprise a reinforcing resin.

36. The tread according to claim 31, wherein the reinforcing filler of the composition having a low stiffness modulus is present in the composition having a low stiffness modulus at a concentration ranging from 10 to 160 parts by weight per hundred parts of elastomer, phr.

37. The tread according to claim 31, wherein the crosslinking system of the composition having a low stiffness modulus is present in the composition having a low stiffness modulus at a concentration ranging from 0.1 to 5 phr.

38. The tread according to claim 30, wherein the composition having a high stiffness modulus is an elastomeric composition based on an elastomeric matrix, at least one reinforcing filler and at least one crosslinking system.

39. The tread according to claim 38, wherein the elastomeric matrix of the composition having a high stiffness modulus comprises a diene elastomer.

40. The tread according to claim 38, wherein the reinforcing filler of the composition having a high stiffness modulus predominantly comprises carbon black.

41. The tread according to claim 38, wherein the crosslinking system of the composition having a high stiffness modulus comprises a crosslinking agent selected from the group consisting of sulfur, a sulfur donor, a peroxide, a bismaleimide, and mixtures thereof.

42. The tread according to claim 38, wherein the composition having a high stiffness modulus comprises at least one reinforcing resin.

43. The tread according to claim 42, wherein the reinforcing resin is selected from the group consisting of polyepoxide resins, melamine/formaldehyde resins, phenol/formaldehyde resins, urea/formaldehyde resins, polyurethane resins, unsaturated polyester resins, vinyl ester resins, polyimide resins, diallyl phthalate resins, allyl diglycol carbonate resins and polyorganosiloxane resins.

44. The tread according to claim 38, wherein the reinforcing filler of the composition having a high stiffness modulus is present in the composition having a high stiffness modulus at a concentration ranging from 10 to 160 phr.

45. The tread according to claim 38, wherein the crosslinking system of the composition having a high stiffness modulus is present in the composition having a high stiffness modulus at a concentration ranging from 0.5 to 40 phr.

46. The tread according to claim 30, wherein the composition having a high stiffness modulus is a thermoplastic or comprises a thermoplastic elastomer.

47. The tread according to claim 46, wherein the thermoplastic is selected from polyolefins, vinyl chloride polymers, polystyrenes, polyamides, polyesters, ethylene/vinyl alcohol copolymers, polyacrylates, polyacetals and mixtures thereof.

48. The tread according to claim 46, wherein the thermoplastic is rendered adhesive.

49. The tread according to claim 46, wherein the thermoplastic elastomer is selected from thermoplastic styrene elastomers, ether/amide block copolymers, copolyesters, thermoplastic polyurethane elastomers, vulcanized thermoplastics, thermoplastic polyolefins and mixtures thereof.

50. The tread according to claim 30, wherein the modulus E_{H}, and the fraction by volume ϕH of the composition having a high modulus, and the modulus E_{B}, and the fraction by volume ϕB (or 1−ϕH) of the composition having a low modulus, are defined such that the formula
$$\frac{α}{[ φ H + ( 1 - φ H ) α ] [ φ H α + ( 1 - φ H ) ]} , in which α = {E}_{H} / {E}_{M} ,$$
is less than 0.67.

51. The tread according to claim 30, wherein the modulus of extension at 5% deformation of the composition having a low stiffness modulus is within a range extending from 3 to 6 MPa.

52. The tread according to claim 30, wherein the modulus of extension at 5% deformation of the composition having a high stiffness modulus is within a range extending from 30 to 300 MPa.

53. The tread according to claim 30, wherein the volume of the layers of the composition having a low stiffness modulus represents from 50 to 95% by volume of the tread pattern of the tread.

54. The tread according to claim 30, wherein the layers of the composition having a low stiffness modulus have a thickness within a range extending from 1 to 20 mm.

55. The tread according to claim 30, wherein the layers of the composition having a high stiffness modulus have a thickness within a range extending from 0.1 to 20 mm.

56. The tread according to claim 30, wherein the layers of the composition having a low stiffness modulus and the layers of the composition having a high stiffness modulus are arranged alternately.

57. A tire comprising a tread according to claim 30.

58. The tire according to claim 57, wherein the tire is a tire for civil engineering vehicles or heavy-duty vehicles.
